(19) United States
(12) Patent Application Publication
(10) Pub. No.: US 2004/0026322 A1
(43) Pub. Date: Feb. 12, 2004

(54) Process and apparatus for adsorptive separation of substances

(75) Inventors: Dietmar Nussbaumer, Gottingen (DE); Wolfgang Demmer, Gottingen (DE)

Correspondence Address: CASELLA & HESPOS, 274 MADISON AVENUE, NEW YORK, NY, 10016

(73) Assignee: Sartorius AG, Gottingen (DE)

(21) Appl. No.: 10/461,774

(22) Filed: Jun. 12, 2003

(30) Foreign Application Priority Data
Aug. 9, 2002 (DE) DE 102 36 664.0

(51) Int. Cl. B01D 11/00

(52) U.S. Cl. 210/644; 210/635; 210/656; 210/663; 210/660; 436/161; 210/634

(57) ABSTRACT

The present invention relates to a process which can be carried out continuously for the adsorption separation of substances in liquid media, in which process a flat adsorbent is loaded with an adsorbate by contacting the adsorbate-containing medium with the entire adsorbing outer surface of the adsorbent without forced flow through, and to an apparatus for carrying out the inventive process.

### BACKGROUND OF THE INVENTION

The present invention relates to a process for continuous adsorption separation of substances in liquid media, in which a flat adsorbent is loaded with an adsorbate by bringing the adsorbate-containing medium into contact with the entire adsorbing outer surface of the adsorbent without forced flow, and to an apparatus for carrying out the inventive process.

In the prior art, the following fundamental adsorption processes and basic types of adsorbers employed for carrying them out are known:

(i) Column chromatography in which the medium or the eluent flows through the interparticulate regions of a bed of a particulate adsorbent which is situated in a cylindrical hollow body, i.e, the annular gap between two cylinders or a comparable cavity (chromatography column).

(ii) What is called the expanded-bed process of adsorption, in which the medium or the eluent fluidizes and flows past a particulate adsorbent in a chromatography column.

(iii) Membrane chromatography, in which the medium or the eluent flows past a flat adsorbent which has continuous pores and is situated in a filtration apparatus. The flat adsorbent usually consists of one or more layers of an adsorption membrane.

(iv) The batch adsorption process, in which the adsorbent is loaded via movement in the medium, the medium flowing past the adsorbent. This can be performed, for example, using a particulate adsorbent in a stirred tank, whereupon the adsorbent, in a second step, is separated from the residual medium and, if appropriate in a third step, the elution is carried out, for example in a chromatography column. A variant is that a flat adsorbent is moved in an apparatus for loading and elution (German laid-open application DE 4028357 A1).

The productivities which can be achieved using the processes indicated under the above points (i) to (ii), that is to say the amounts of adsorbate which can be produced or removed per unit amount of adsorber per unit time are restricted by the fact that during constant loading only a part of the adsorbent is participating in the adsorption process, that is to say that part which in the incompletely loaded state is in contact with the adsorbate-containing medium. The remaining amount of the adsorbent is either already loaded or is in contact with the target medium, that is to say the medium in which an intended depletion of an adsorbate has already been achieved. These non-adsorbing, and as a result unproductive, regions can, in the case of relatively tall columns, make up the majority of the adsorbent. In addition there is the fact that, owing to their hydraulic resistance, they not only make a substantial contribution to the pumping energy required, but also limit the achievable flow velocities of medium and eluent, which, as a result of the required long loading and elution times thus caused, further decreases the productivity.

A further disadvantage of the process mentioned under point (i) is that a chromatography column does not allow particles to pass. The expanded-bed process (ii) is said to enable the use of particle-containing media. However, this process is highly complex, not only as relates to the production of the corresponding particulate adsorbents (for example Streamline™ gels, Pharmacia, Uppsala, Sweden), which require a multiplicity of graded densities, but also maintenance of the required operating conditions (flow velocities of medium and eluents depending on their density).

For particle-containing media, a multiplicity of variants of membrane chromatography (point (iii)) are known which are based on the fact that flow passes not only around but also through adsorption membranes, the two streams either leaving the adsorber on separate paths, or being internally remixed. The proportion flowing through results here from the pressure difference which results or is maintained on the two sides of the membrane. Krause et al. in BIO forum 12/92, p. 455 and in Biotechnology Techniques 5(3), pp. 199-204 (1991) describe the use of adsorption membranes in cross-flow filtration apparatuses. Here, a particle-loaded medium is passed tangentially over the membrane(s), while the adsorbate is bound in the membrane. After removing the particles by rinsing, the adsorbate can be eluted. A serious disadvantage of the process is the pressure difference inevitably occurring between channel inlet and channel outlet during a cross-flow operation, which pressure difference leads to differing flow rates of the membrane and thus to non-uniform loading.

A particle-passing modification of a statically (that is to say without crossflow) operated membrane adsorber is described in DE 199 43 921 C1. Here, a portion of the medium flows through the membrane(s), while the particle-loaded main stream passes the adsorbent in the bypass through orifices present.

The batch process using particulate adsorbents (iv) is very complex, because the requirement for differing apparatuses for loading, separation and elution into which the adsorbent must be transported, and is therefore only used in isolated cases. Although the above-mentioned variant using a flat adsorbent, compared with the above-mentioned, has the advantages of passing particles and that only one apparatus is required, the two processes share the disadvantage that they are carried out in mechanically moved apparatuses, in which the sterile operation usually required in, for example, the pharmaceutical sector, can be achieved only with great difficulty (encapsulation etc.), if at all.

It is therefore an object underlying the present invention to provide a process for adsorption separation of substances which overcomes said disadvantages of the prior art adsorption processes, which disadvantages are, in particular, the low productivity achievable, the high hydraulic resistances occurring, the lack of ability to pass particles of the adsorbers used and/or their complexity, and to provide an apparatus which makes it possible to carry out the inventive process industrially.

This object is achieved by the embodiments of the present invention featured in the claims.

In particular, a process is provided for adsorption separation of substances in liquid media comprising the steps:

(a) providing an adsorber having a flat adsorbent which is disposed at a fixed point in a housing and has at least one adsorbing surface which delimits at least one flow channel of constant cross section, the housing having at least one inlet and at least one outlet for liquid medium and the inlet being connected to one end of the flow channel/flow channels and the outlet being connected to the other end of the flow channel/flow channels in such a manner that the hydraulic pressure of the medium is constant over the entire cross section of the flow channel/flow channels on the inlet side and outlet side, and

(b) optionally equilibrating the adsorbent with a liquid medium, and

(c) continuously contacting the flat adsorbent in the housing with the liquid medium which comprises at least one adsorbate by applying a pressure difference between inlet and outlet.

In the inventive process, the flat adsorbent is thus constructed in such a manner that, firstly, the medium comes into contact with the entire outer adsorbing surface of the adsorbent. In the case of adsorber materials through which flow can pass in a direction transverse to the main direction of flow, for example porous membranes, it is preferred that at respectively opposite points of the two surface sides of the adsorber material through which flow can pass essentially equal pressure conditions or flow velocity conditions prevail, so that, in the case of adsorption membranes also, no forced flow of the adsorbent takes place. This ensures that all of the adsorbent used in the inventive apparatus participates in the adsorption process (and if appropriate in a subsequent elution).

Preferably, the inventive process further comprises the step

(d) contacting with an eluent the adsorbent which has at least one adsorbate which was adsorbed thereto in step (c).

The following definitions underlie the present invention.

“Adsorption separation of substances” is taken to mean according to the invention removing one or more component from a fluid phase by selective adsorption of this component (these components) to a solid phase, the “adsorbent”. The field of the invention relates to separation of substances in liquids, the liquid being termed below “medium” and the apparatus in which the adsorption is carried out being termed “adsorber”.

The components can be one of more target substances and/or one or more contaminants. “Target substances” are substances of value which are to be recovered from the medium in enriched or pure form; “contaminants” are those whose absence is required or is desirable for technical, regulatory or other reasons. For the removal of contaminants, which is termed “negative adsorption”, the adsorption can (may) proceed irreversibly if the adsorbent is only to be used once. In the case of adsorption of the target substance(s), the process must proceed reversibly. Either simple enrichment can be carried out, or separation into a plurality of target substances can be carried out, in the latter case either the adsorption, the desorption, or both can proceed selectively.

Target substance(s) and/or contaminant(s) are termed “adsorbate” according to the invention, and the singular is used, which, however, is not to exclude the fact that this can also involve a plurality of different substances. Medium from which the adsorbate has been wholly or partly removed as a result of adsorption is termed “depleted medium”; medium which has already undergone an intended depletion is termed “target medium”. The term “elution” combines desorption and the accompanying wash steps etc; the liquid used for elution is the “eluent”.

The amount of the adsorbate adsorbed in the equilibrium between medium and adsorbent, based on the amount of the adsorbent, is called “capacity” and that present in the case of partial load, in relation to the capacity, is called “degree of loading”; the time for which the adsorption is carried out is called “loading time”. The adsorption properties of an adsorbent are described by the “adsorption isotherms” (capacity as a function of the concentration of the adsorbate in the medium) and the “loading kinetics” (degree of loading as a function of loading time for a given initial concentration). “Cycle time” is taken to mean the total of loading time and “elution time” (time required for elution), and “productivity” is taken to mean the amount adsorbate adsorbed in relation to the cycle time and the amount of adsobent.

Adsorption and desorption generally take place as heterogeneous reactions on the outer (geometric) and inner (pore) surface of the adsorbent. High values of the “outer specific surface area”, of the geometric surface area/volume ratio, are achieved by limiting the geometric expanse of the adsorbent in two or three directions of the space. Accordingly, “flat”, “fibrous”, or “particulate” adsorbents are spoken of.

Flat adsorbents which are usable in the inventive process can be constructed planar, or as enclosed surfaces, for example tubing, pipes and capillaries. In the case of tubing, pipes and capillaries, “outer surface” is taken to mean the inner and/or outer jacket surface(s). They can also be flat materials made of fibrous adsorbents, for example nonwoven webs and fabrics made of fibrous adsorbents, for example products from CUNO Inc. having the names Zetaprep® S or Zetaprep® DEAE or materials made of inert (inactive in adsorption) flat supports, in or on which particulate adsorbents are fixed, for example products of FMC having the names Actidisk® SP or Actidisk® CM.

The “inner specific surface area”, the ratio of the surface area of the pores of the adsorbent, which are connected to its outer surface and can be either “continuous pores” or “dead end pores”, to its volume can, in the case of a high-capacity adsorbent, make up the predominant proportion of its entire specific surface area. Flat adsorbents having continuous pores in the pore size range of about 0.1-10 μm are called according to the invention “adsorption membranes”, and those without continuous pores are called “adsorption films”.

The effect of the inner specific surface area on the loading and elution rates depends on the flow route of the medium, with a distinction needing to be made between “flow round” and “flow through” (flow through continuous pores).

The ratio of flow through to flow round can vary within broad limits for differing adsorbents and adsorbates, more precisely between a through-flow proportion of 0 in the case of nonporous adsorbents or those only having dead-end pores, and 100% in the case of flat adsorbents having continuous pores which are operated in adsorbers having “forced throughflow” (flow route without the possibility of flow round in a bypass). “Partial throughflow” is present when the adsorbent has continuous pores and, as a result of the structural features of the adsorbent, a hydrostatic pressure difference occurs between the inlet and outlet orifices of the pores and flow round the adsorber is also possible. These preconditions can be set not only in the case of adsorbers containing particulate and fibrous adsorbents, but also flat adsorbents.

There are adsorbents whose inner surface area is not defined strictly geometrically as the result of environmentally-dependent swelling and shrinking processes. Adsorbents of this type consist of two solid phases, an inert support structure and an adsorbent swellable phase, whose adsorption activity is not restricted to their phase boundary with the medium, but extends over the entire volume of the swellable phase. This phenomenon, termed below “swelling porosity”, can occur, for example, when the adsorbent consists of an inert support and a grafted adsorbent swellable polymer. The specific surface area of an adsorbent of this type is taken to mean the surface area/volume ratio in the shrunken state of the swellable phase.

Flat adsorbents which not only have an adsorbing side, which can also be porous, but also have an inert non-porous side, are called according to the invention “asymmetric” flat adsorbents. These can be, for example, a tubular adsorbent having a dense outer skin, a flat adsorbent laminated to a film, a particulate adsorbent fixed to a film, or an adsorbing polymer grafted on one side to an inert film.

Generally, high binding and elution rates can be achieved either using non-porous adsorbents, which have low capacities however, or using porous adsorbents having a high throughflow proportion. It is explained by the fact that the mass transport of the adsorbate proceeds by convection (rapidly close) not only in flow round non-porous adsorbents, but also in flow through porous adsorbents, but during flow through porous adsorbents, in contrast, it proceeds by diffusion to a considerable proportion, that is to say slowly. This phenomenon is termed “diffusion-limitation of mass transport”.

“Particle-passing ability” of an adsorber is taken to mean its insensitivity to blockage by particle-containing media. A blockage can occur not only in the case of flow past adsorbents in narrow channels between adsorbent particles, but also in flow through adsorbents. The particle-passing ability is, furthermore, associated with insensitivity to gases in the medium.

According to a further preferred embodiment of the process, the at least one adsorbate-containing liquid medium additionally comprises particles. These particles can either be contaminants of the medium; for example cell debris and cell constituents, or can be constituents giving value, which must therefore not be lost or removed. The latter case applies, for example, in decontamination (removal of interfering accompaniments such as pyrogens, DNA etc.) of vaccines, virus suspensions, bacterial suspensions or suspensions of liposomes. Further particulate target substances can be eukaroyte cells, unicellular or multicellular low organisms such as algae, protozoa, yeasts or fungal spores, and in addition cell organelles such as nuclei, mitochondria, lysosomes, proteosomes etc. The size of the particles which can be present can extend up to the order of magnitude of the clearances of the adsorber and is then, in addition, upwardly limited by the flowability of the medium.

The disadvantages of the processes of the prior art are of different relevance to the various processes occurring in practice. The advantages of the inventive process compared with the known processes of the prior art are therefore explained in more detail hereinafter with reference to example model processes:

Model process A: removal of a substance of value present at low concentration from a low-value medium, in particular the production of food additives.

Examples: production of lactoferrin from whey or lactoperoxidase from whole milk by ion exchange (see example 3). Technical problems: very large volumes of medium must be processed which is at the same time particle-containing and difficult to filter, where in the prior art, to remove the residual casein micelles and lipids in preclarified whey, a further prefiltration is required, for example by microporous membranes, which must be so extensive that there is always the risk that not only the particles, but also the target substance, are retained. Essential aspects for the economic efficiency of the entire process are the particle-passing ability of the adsorber and the energy consumption (pumping energy). The completeness of the separation, that is to say the residual content of the target medium of the adsorbate, decreases in relative importance.

Model process B: frequently, biologically active substances are produced in cell culture, the target substance being released into the medium from which it is to be recovered. In this process the cells must be removed in advance by centrifugation and/or filtration and the medium recirculated.

Example: if the target substance is depleted from the cell-containing medium, this medium can be recirculated directly. In this case the particle-passing ability is the principal economic aspect.

Model process C: removing an adsorbate using an expensive ligand. In particular in biotechnology, there are applications in which the production costs of the adsorbent are extremely high, for example if certain affinity ligands are required, for example antibodies, protein A etc. If the adsorbate is a contaminant, repeated use is frequently not economically justifiable because of the validation expense associated with regenerating the adsorbent. In these cases, maximizing the productivity of the adsorbent is the principal economic aim of the process.

Example: producing an active human compound using genetically manipulated mammal cells. The active animal compound present in small amounts is to be removed by affinity adsorption to an antibody which is produced solely for this use.

Model process D: removing a contaminant which leads to degradation of the target substance.

Example: removal of proteases from protein-containing media. The principal aim of the process is the removal as rapidly as possible of the majority of the contaminant to maximize the yield of target substance.

The importances of the favorable properties of the inventive process for the above-mentioned model processes can be weighted as follows:

| Features of the inventive | Importance for model process | | | |
|---|---|---|---|---|
| process: | A | B | C | D |
| Particle-passing ability | 1 | 1 | 2 | 2 |
| High productivity | 2 | 2 | 1 | 1 |
| Achieving low final concentrations | 3 | 3 | 1 | 2 |
| Low hydraulic resistance | 1 | 3 | 3 | 3 |

Rating Scale:

1 of critical importance

2 of importance

3 of low importance

The inventive process can be carried out with all flat adsorbents independently of their mechanism of action and structure. The mechanism of action and the structure of flat adsorbents is known to those skilled in the art from many fields of biotechnology, pharmacy, food engineering and related fields.

By way of example, ligands interacting with the adsorbate or adsorbates which can be mentioned are ion exchangers, chelating agents and heavy metal chelates, thiophilic, hydrophobic ligands of various chain lengths configurations, reversed-phase systems, dye ligands, affinity ligands, amino acids, coenzymes, cofactors and analogs thereof, substrates and analogs thereof, endocrine and exocrine substances, such as hormones and active compounds acting like hormones, effectors and analogs thereof, enzyme substrates, enzyme inhibitors and analogs thereof, fatty acids, fatty acid derivatives, conjugated fatty acids and analogs thereof, nucleic acids, such as DNA, RNA and analogs and derivatives thereof (single-, double- and/or multi-stranded), and peptide nucleic acids and derivatives thereof, monomers and analogs and derivatives thereof, oligomers to polymers and analogs and derivatives thereof, high-molecular-weight carbohydrates, which can be linear or branched, unsubstituted or substituted, polymeric glycoconjugates, such as heparin, amylose, cellulose, chitin, chitosan and also their monomers and oligomers and derivatives and analogs thereof, lignin and derivatives and analogs thereof, other biochemical ligands, such as oligo- and polypeptides, for example proteins and their oligomers, multimers, subunits and parts thereof, in particular lectins, antibodies, fusion proteins, haptens, enzymes and subunits and parts thereof, structural proteins, receptors and effectors and parts thereof, furthermore xenobiotics, pharmaceuticals and active pharmaceutical compounds, alkaloids, antibiotics, biomimetics etc.

The basic principle of the inventive process is thus that all of the adsorbent used participates in the process for the entire process time, which achieves a high flexibility in matching the processing parameters to the requirements of the respective process.

In particular, it is possible by the inventive process to achieve by targeted partial loading high productivities, because the loading rate is highest in the initial phase of loading. The short cycle times achievable by this means, which may be readily automated in process-computer-controlled systems, enable productivities up to the order of magnitude of kg/m²d (see example 5). In the processes of the prior art, rapid partial loading is otherwise only possible in the case of the batch processes (see processes under point (iv) supra) which are usually impracticable and hardly able to be automated for the reasons mentioned above.

In the adsorbers of the prior art, the most-used medium flow route through the adsorber is the “continuous flow process”, in which the medium is passed through the adsorber until its capacity is exhausted. Inventive adsorbers can in addition be operated with advantage in the “recirculation process”, in which a predefined volume of the medium is recirculated through the adsorber until the required depletion of the adsorbate is achieved. Via the predefined “volume/area ratio”, the ratio of the volume recirculated to the area of the adsorbent, the economic efficiency of the process can be decisively influenced, by optimizing this ratio and the recirculation time with adaptation to the economic requirements of the respective process with respect to productivity and yield. This optimization process is described in example 5. A further advantage of the recirculation process is the fact that the recirculation rate which is freely selectable within broad limits permits high flow velocities to be ensured, which are beneficial to mass transport kinetics. Recirculation processes and continuous-flow process can also be used during elution.

A preferred embodiment of the continuous-flow process is the tandem principle, in which the medium flows through at least 2 adsorbers in succession. WO 98/41302 describes a tandem system using membrane adsorbers of the prior art, which accordingly also has its disadvantages. The individual steps of the tandem principle are described in FIGS. 13-15. The following designations appear in the figures: 100 A and 100 B: adsorbers, 101: valves having one inlet and 3 outlets, or having 3 inlets and one outlet, 102 A-107 A, and 102 B-107 B: individual valves for controlling the flow route in the piping from and to the adsorber A or adsorber B, 108: line for feeding eluent, 109: line for feeding the medium, 110: line for removing the eluate, 111: line for removing the target medium. Parts of the piping through which fluid flows are differentiated from those through which fluid does not flow by bold print. The symbol [symbol] means an open valve, and the symbol [symbol] means a closed valve. In the tandem principle, the adsorbers are loaded in series connection, and the connection is reversed during successive loadings. After the loadings, in each case only the adsorber connected in the first position is eluted. After the elution, the freshly eluted adsorber is thus in contact with already depleted medium (preloading), and the already precharged adsorber, in contrast, with the effluent medium (final loading). On account of the equilibrium position of the adsorption (adsorption isotherms), as a result not only a high capacity is achieved during the final loading, but also a low final concentration (high yield) during the preloading. The tandem process can also be carried out using more than 2 adsorbers, so that during the elution of the adsorber finally loaded last the loading of the remainder can be continued. The tandem process is suitable, in particular, for carrying out model process A on an industrial scale, in which case automating control of the individual valves 102 A-107 A and 102 B-107 B required for the flow rate using a process computer is obvious. The tandem principle can also be implemented using the recirculation process, by additionally providing one circulation pump each between fluid inlet 1 and fluid outlet 2 of the adsorbers 100 A and 100 B.

The closer the target concentration is to the value 0 (model processes C and D), the greater are the advantages offered in the case of particle-free media by a further preferred embodiment of the inventive process in which the residual adsorbate remaining in the medium after flow round the adsorbent in the continuous-flow process is bound to a final adsorption membrane with forced throughflow. Thus, preferably, the liquid medium after contacting with the adsorbent in step (c) defined above is filtered through one or more corresponding final adsorption membranes. Obviously, in this case, a plurality of membranes can also be used in series. In this manner it is possible to combine the main advantages of flow round and flow through a flat adsorbent constructed as adsorption membrane: the simultaneous availability of the entire outer surface during the flow round, which achieves a high productivity, and complete binding of the adsorbate to one layer or a few layers of an adsorption membrane during the rapid throughflow of a medium which, after step (c) of the inventive process, already has a relatively low concentration of the adsorbate or adsorbates.

The described combination with membrane chroma-tography can be performed according to the invention either by series connection of an inventive apparatus and a membrane adsorber of the prior art, or in an adsorber in which both adsorption principles are implemented in such a manner that in the housing of the inventive adsorber, one or more final adsorption membranes are disposed upstream of the outlet.

Multiphase media can comprise unwanted solid or gaseous phases such as particles or gas bubbles. However, these can also be specifically added to the medium after the inventive process. During elution preferably carried out to produce the adsorbate, gas bubbles or solid displacement bodies can be specifically introduced into the eluent in order to reduce the volume required thereof and as a result to increase the concentration of the desorbed adsorbate in the eluate. It is also possible to use smaller volumes of medium or eluent than corresponds to the dead volume of the adsorber, by first introducing this volume of fluid into the adsorber in a first step and, in a second step, passing an inert gas through the liquid phase from the bottom in such a manner that this liquid phase comes into contact with the entire surface of the adsorber.

Another aspect of the insensitivity of the inventive apparatus to the presence of a gas phase is that, during change of the fluid with which the adsorbent is to come into contact, the preceding fluid can be displaced in advance by introducing an inert gas, which not only makes possible savings in the relevant fluid, but also in process time, especially if a plurality of wash steps are required. In addition, the inventive apparatus can also be stored in the gas-filled dry state, provided that the resistance properties of the adsorber permit this.

The adsorbent is constructed according to the invention preferably as adsorption membrane or adsorption film. According to a further preferred embodiment, the adsorbent is disposed in the housing in multiple layers, for example the adsorbent can be wound in a spiral around a fluid-tight core and inserted, so arranged, into the housing. In particular, it is preferred to provide, between the adsorbent layers through which flow can pass tangentially, a spacing between the devices producing the adsorbent layers (spacers). Another possibility is a capillary-type development of the adsorbent.

The binding kinetics can be beneficially influenced according to the invention by measures for promoting mass transfer at the phase boundary between adsorbent and medium. These include high flow velocities and the production of microturbulence. The latter can be achieved, for example, by using spacers which counteract the formation of laminar flow conditions, for example cloth or corrugated films. A further measure of this type is pulsed transport of the medium, which also counteracts settling of particles on the adsorbent or spacer.

The spacers are preferably textile or nontextile, flat materials through which flow can pass laterally, and are made of inert materials which have no dead corners promoting settling of particles and/or gas bubbles. Nontextile flat structures through which flow can pass can be nonwovens or embossed films. Embossed films are taken to mean flat structures which can be produced by embossing, extrusion, swaging or other processes known in the prior art. Also, flow can, but need not, pass through transversally. In selection of the spacers, the following aspects are to be taken into account: high ability to pass flow-through to minimize the pressure drop, small thickness to ensure high packing density, low clear cross sectional area to minimize the dead volume, low contact area with the flat absorbent to minimize hindering of mass transport, promotion of mass transport, for example by generating microturbulence. The two aspects last mentioned relate to the effect of the spacer on the kinetics of mass transport. This can, as shown in example 5, be described by a kinetic parameter which can be determined with great accuracy, which also applies to the effect of recirculation rate on binding kinetics.

Among non-textile spacers, embossed films are particularly preferred. Suitable embossed films have, on one or both sides of the surface, elevations which determine the distance to the flat adsorbent. Linear elevations are termed ridges below. The elevations or ridges can be disposed on one side (see FIG. 4), or on both sides, of the embossed film (see FIG. 5). Embossed films furnished with ridges only on one side, when membranes are disposed on both their sides are preferably used in two layers with the ridge-free sides facing each other, so that the ridges, together with the flat adsorbent, generate flow channels.

When tubular flat adsorbents are used, according to the invention there is the possibility of integrating the spacer in the mechanical support element required in this case. FIG. 12 shows an arrangement in cross section, in which a tubular adsorbent encloses a profiled support element in such a manner that its profile forms, together with the adsorbent, flow channels. If the profile of the support element has ridges, these can be constructed helically having the helix angle

$$α \neq 0 ,$$

as a result of which, at a given feed rate or recirculation rate of the fluid, its flow velocity can be increased by a factor

$$\frac{1}{cos ( α )}$$

compared with the angle α=0, and as a result the mass transport between fluid and adsorbent can be promoted.

As already described above, the adsorbent is preferably disposed in the housing in multiple layers. For example, it can be disposed in a spiral shape coiled in the housing around a fluid-tight core. Preference is also given to an arrangement in which devices are provided between the adsorbent layers which generate a spacing between the adsorbent layers and through which flow can pass tangentially. However, it is also possible to form the adsorbent not in layers, but in capillary form.

The inventive apparatus can, as already shown above, further comprise a final adsorption membrane which is arranged in such a manner that the medium is filtered through the final adsorption membrane after the contact with the adsorbent, from which there result the above further advantages. The final adsorption membrane can be disposed, on the one hand, in the same housing as the adsorbent. However, it is also possible to dispose the final adsorption membrane in a separate housing downstream of the outlet of the housing holding the adsorbent.

Simultaneous arrangement of the membrane in parallel with a device which generates a fixed defined spacing between the membrane layers produces a particle-passing channel. By using this package of membranes arranged sandwich-like and matching spaces in a matching hollow body, an adsorber bed is provided, which on the one hand is particle-passing, but on the other hand is simultaneously capable of adsorption of substances transported by diffusion into the membrane.

The particle-containing fluid is passed along tangentially to the membrane by generating a pressure difference between inlet and outlet of the adsorber bed in the channels mentioned or in the continuous annular channel. The target substances diffuse into the adsorber membrane and are preferably reversibly bound by adsorption to the corresponding ligands. After removing the particles from the channels by washing with suitable fluids, the target substance can be detached from the adsorber and thus recovered by changing the conditions.

As described above, in a preferred embodiment of the inventive apparatus, a web of the flat adsorber is coiled together with a web of the spacer around a shared core and disposed, for example, in a cylindrical housing. The cylindrical housing has an intake for the liquid medium (fluid inlet) at its one end and an outlet for the liquid medium (fluid outlet) at its other end. During loading the medium is passed tangentially along the adsorbent, and during regeneration of the adsorbent, or elution of the target substance, the regeneration medium, or the eluent, respectively.

### BRIEF DESCRIPTION OF THE DRAWINGS

FIG. 1 shows a graphical representation which shows the concentration of the adsorbate as a function of loading time (according to example 1). Continuous curve: approximation of the measured values by the fitting function C=f(t) mentioned in example 5. The points given by the coordinates t and C correspond to the measured values in table 1.

FIG. 2 shows a graphical representation which shows the productivity P at an elution time of 10 min as a function of the loading time t. Continuous curve: calculated from the parameters of the fitting function C=f(t). The points given by the coordinates t and P correspond to the productivities calculated from the measured values in table 1.

FIG. 3 shows a light-microscopic surface view of a profiled film having breakthroughs of the type “Delnet® Nonwoven Fabrics RO412-10-10PR” from Applied Extrusion Technologies, Inc. United Kingdom, having ridges disclosed on one side, in a view from the ridge-free side. Enlargement 13×.

FIG. 4 shows a scanning-electron micrograph of the same profiled film as in FIG. 3, cross section in the region of a ridge. Enlargement 150×.

FIG. 5 shows a cross section through a profiled film without breakthroughs having ridges disposed on both sides.

FIG. 6 shows a diagrammatic representation which shows a longitudinal section through a preferred embodiment of the inventive apparatus. In this embodiment, the adsorbent, which is constructed as a membrane, and the space-producing device are wound up on a fluid-tight, rod-like core. The designations have the following meanings: 1 inlet of the housing, 2 outlet of the housing, 3 housing, 4 space-producing device, 5 adsorption membrane, 6 fluid-tight core for wind-ing up the combination of membrane and space-producing device, 7 apparatus for distributing the fluid at the respective inlet and outlet of the housing.

FIG. 7 shows a cross section made perpendicularly to the longitudinal axis of the apparatus shown in FIG. 6 at the level of line A-A. The designations have the following meanings: 3 housing, 4 spacer, 5 adsorption membrane, 6 fluid-tight core.

FIG. 8 shows a further preferred embodiment of the inventive apparatus. Here the membranes and the space-producing devices are disposed in parallel to the longest longitudinal axis and to a transverse axis of a right-angled housing. The designations have the following meanings: 1 inlet of the housing, 2 outlet of the housing, 3 housing, 4 spacer, 5 adsorption membrane, 7 apparatus for distributing the fluid at the inlet and outlet of the housing.

FIG. 9 shows a cross section of an apparatus shown in FIG. 8 at the level of the line B-B. The designations have the following meanings: 3 housing, 4 spacer, 5 adsorption membrane.

FIG. 10 shows a preferred arrangement of the adsorption membrane 5 which is disposed in a folded (pleated) form around the fluid-tight core 6. For reasons of clarity, the spacers and the housing are omitted. Only one membrane layer is shown.

FIG. 11 shows a cross section of the further embodiment of the inventive apparatus having the adsorbent in the arrangement according to FIG. 10. Here the membranes and the spacers are disposed in pleated form in parallel to the longitudinal axis of a cylindrical housing. The designations have the following meanings: 3 housing, 4 spacer, 5 adsorption membrane, 6 fluid-tight core.

FIG. 12 shows the cross section through an adsorber consisting of a tubular adsorbent 10 and a support element 11 which is enclosed by this adsorbent and is formed as a spacer and has ridges 12.

FIG. 13 shows a tandem installation, step 1: preloading the adsorber 100 B, which was eluted in the preceding step. The adsorber 100 A undergoes final loading at the same time.

FIG. 14 shows a tandem installation, step 2: elution of the finally-loaded adsorber 100 A.

FIG. 15 shows a tandem installation, step 3: preloading adsorber 100A and final loading of the adsorber 100 B which was preloaded in step 1 and preloading of adsorber 100 A.

### DETAILED DESCRIPTION OF THE INVENTION

The present invention will be described in more detail by the non-limiting examples below.

### EXAMPLES

### Example 1

### Binding of Bovine Serum Albumin (BSA) by the Recirculation Process.

A commercially conventional adsorption membrane having the properties of a weakly basic ion exchanger (trade name SARTOBIND® D, Sartorius AG) of width 30 cm and length 160 cm, corresponding to 0.48 m², was wound onto an inert plastic rod together with two profiled films (name: Delnet® Nonwoven Fabrics RO412-10-10PR from Applied Extrusion Technologies, Inc. United Kingdom) of a thickness of 0.254 mm. The profiled films were placed with the ridge-free side next to one another, so that the ridges of the films formed channels on both sides in the axial direction together with the adjacent membrane. The coil was inserted into a tube having an internal diameter of 4.3 cm, tightly against the inner wall of the tube. The ends of the tube were closed with two bored rubber stoppers in such a manner that, between the stopper and the coil, a space resulted for distributing or collecting the influent and effluent fluid. The dead volume of the resultant adsorber including the tubes was 420 ml.

The adsorber was washed with 0.02M Tris-HCl pH 8.3 (called Tris hereinafter). A solution of 2 g of BSA (from Kräber, Hamburg) in 1 L of Tris was recirculated from a reservoir using a peristaltic pump at 300 ml/min through the Tris-filled adsorber from the bottom. The volume of the recirculated medium, including the wash buffer present in the dead volume of the adsorber was 1.421. Table 1 gives the BSA concentration c which was determined in the reservoir from the extinction at 280 nm after suitable dilution, and the loading time t. The amount of BSA adsorbed calculated from the decrease in concentration by the end of loading was 1.78 g.

Table 1: Loading Time t and BSA Concentration c

| t [min] | c [g/l] |
|---|---|
| 0 | 1.41 |
| 3 | 1.14 |
| 7 | 0.73 |
| 10 | 0.68 |
| 15 | 0.36 |
| 20 | 0.24 |
| 25 | 0.19 |
| 30 | 0.16 |

### Example 2

### Elution of BSA by the Continuous-Flow Process

After the loading in example 1, in the continuous-flow process, the adsorber was washed with 1 l of Tris and eluted with 1 L of 1 M NaCl in 0.01 M potassium phosphate buffer pH 7.0 at 160 ml/min. The BSA concentration was determined in the same manner as in example 1 in 100 ml fractions of the eluate. Table 2: Course of the elution of BSA in the continuous-flow process with 160 ml/min of 1 M NaCl

| Fraction | g/l of BSA | % of eluted BSA |
|---|---|---|
| 1 | 0.09 | 0.5 |
| 2 | 0.44 | 2.5 |
| 3 | 4.71 | 26.9 |
| 4 | 3.40 | 19.4 |
| 5 | 3.57 | 20.4 |
| 6 | 2.42 | 13.8 |
| 7 | 1.40 | 8.0 |
| 8 | 0.70 | 4.0 |
| 9 | 0.49 | 2.8 |
| 10 | 0.28 | 1.6 |

The amount of BSA eluted was 1.75 g, equivalent to 87.5% of the amount used (2 g) or 98.3% of the amount adsorbed (1.78 g). Fractions 3 to 7 contained 88.6% of the eluted protein. The concentration of fraction 3 corresponds to a 3.3 fold on compared with the starting solution.

### Example 3

### Production of Lactoperoxidase (LP) from Whole Milk by the Recirculation Process

LP was determined on the basis of the publication “biochemical information” from Boehringer Mannheim GmbH (Biochemica 1987 p. 49) according to the following protocol.

Definition of one unit (U) of LP: 1 U oxidizes 1 mmol of azinobis(ethylbenzthiazoline-6-sulfonic acid) (ABTS) in 1 min at 25° C. and pH 5.5

In a semi-microcuvette, 0.6 ml of 0.05 M sodium acetate pH 5.5, 0.3 ml of a solution of 6.2 mg of ABTS (catalog No. A1888, from Sigma, Deisenhofen) in 1 ml of 0.05 M sodium acetate pH 5.5, 0.025 ml of a solution of 0.1 ml of Perhydrol in 25 ml of water and 0.005 ml of sample were mixed thoroughly and the increase in extinction at 436 nm ΔE436 was determined after 1 min.

Calculation:

$$\frac{Δ E436}{0.146} = \frac{U}{ml}$$

A commercially conventional adsorption membrane having the properties of a strongly acidic ion exchanger (trade name SARTOBIND® S, Sartorius AG) of width 2.8 cm and length 150 cm, corresponding to 0.042 m² or 115 ml of membrane, was combined in the same manner as in example 1 with profiled film to give an inventive adsorber, where the internal diameter of the tube was 5.2 cm and the dead volume of the adsorber was 27 ml, with tubes 100 ml. After washing with 0.01 mol/l of phosphate buffer pH 7.0 (KPi), 0.2 l of fresh whole milk available in the food trade and containing 2252 U of LP were recirculated at about 400 ml/min through the adsorber. The volume, including the wash buffer situated in the dead volume was thus 300 ml.

Table 3: Loading Time t and Lactoperoxidase Concentration c

| t [min] | c [U/L] |
|---|---|
| 0 | 7500 |
| 1 | 6980 |
| 6 | 6340 |
| 25 | 2790 |
| 47 | 1430 |
| 70 | 480 |

After loading, the adsorber was washed with KPi until the effluent was virtually clear and was then eluted with 28 ml of 1 M NaCl in KPi in continuous flow, with 902 U of LP, equivalent to 64% of the amount adsorbed, being recovered. No further study was made of whether the amount of enzyme not recovered was due to its partial inactivation, or incomplete elution. In any case, the essential result of the experiment is that the inventive process makes it possible to recover LP even from whole milk, and therefore in an industrial process starting from whey, no requirement for a complex prefiltration is expected.

### Example 4

### Production of Substances by the Recirculation Process from a High Particle Load

The apparatus of example 1 was used and also the procedure of example 1 was followed, with the following exceptions:

14.4 g of dried yeast obtainable in the food trade was suspended in the BSA solution and the medium situated in the reservoir was intensively mixed with a magnetic stirrer to prevent sedimentation. The samples taken from the reservoir, before determining the extinction at 280 nm in a suitable dilution, were centrifuged at 13 000×g for 2 min to remove particles. The concentration of the substances absorbing at 280 nm, called “protein” hereinafter, was calculated using BSA standard. Non-centrifuged parallel samples were diluted 1:10 with Tris immediately after sampling and the extinction was determined at 600 nm as an index of turbidity (see table 4).

A protein binding of 4.32 g was obtained by calculation from the decrease in concentration.

TABLE 4
Loading time t, concentration c of the substances
absorbing at 280 nm, calculated as BSA, and
turbidity index E 600

| t [min] | c [g/l] | E 600 1:10 diluted |
|---|---|---|
| 0 | 3.76 | 1.47 |
| 2 | 1.8 | 1.55 |
| 10 | 0.88 | n.d. |
| 15 | 0.78 | n.d. |
| 20 | 0.72 | 1.50 |

The apparatus was then washed with 10 l of Tris, in which case the wash liquid appeared slightly turbid at the start, and elution was performed in a two-stage continuous-flow process at 0.4 I/min. The first stage was performed using 1.14 l of 0.25 M NaCl in Tris, and the second stage using 0.44 l of 1 M NaCl in Tris. The adsorbent was then regenerated in the recirculation process using 1 l of 0.1 M NaOH in water for a time of 30 min at 0.4 l/min. In the eluates and the neutralized regeneration liquid, protein concentration and the turbidity were determined as above, the dilution step being omitted for the latter (see table 5).

Table 5: Substances absorbing at 280 nm recovered in the eluate fractions and the regeneration solution, calculated as BSA and turbidity index E 600

| Sample | Protein [g] | E 600 |
|---|---|---|
| Eluate 1 | 1.07 | 0.034 |
| Eluate 2 | 0.6 | 0.04 |
| Regenerate | 2.66 | 0.036 |

Virtually all of the bound protein was thus recovered, but only 38.7% of this was recovered in the eluates. This shows that predominantly soluble yeast components had been bound and not BSA, which, as example 1 implies, is completely elutable from the membranes used. Although the turbidity measurement used is not strictly quantitative, it may be estimated from the values measured that less than 0.5% of the turbidity passed into the eluate and the regeneration solution.

### Example 5

### Determination of Capacity and Binding Kinetics, and Process Optimization in the Recirculation Process (Example Calculation)

Capacity and binding kinetics are much easier to follow by measurement in the recirculation process and are mathematically simpler to describe than in the continuous-flow process because, assuming a sufficiently high recirculation rate, concentration of the medium and loading state of the adsorbent do not show local differences. Some results obtained, for example the effect of certain spacers or of the flow velocity can be applied directly to the continuous-flow process, others, for example productivity and yield, only as trends.

It was established that the decrease of concentration with time (measured values of tables 1, 3 and 4 of examples 1, 3 and 4) are given with close approximation (correlation coefficient>0.99) by the following function:

$$C = {a}_{0} exp ( - {a}_{1} t ) + {a}_{2}$$

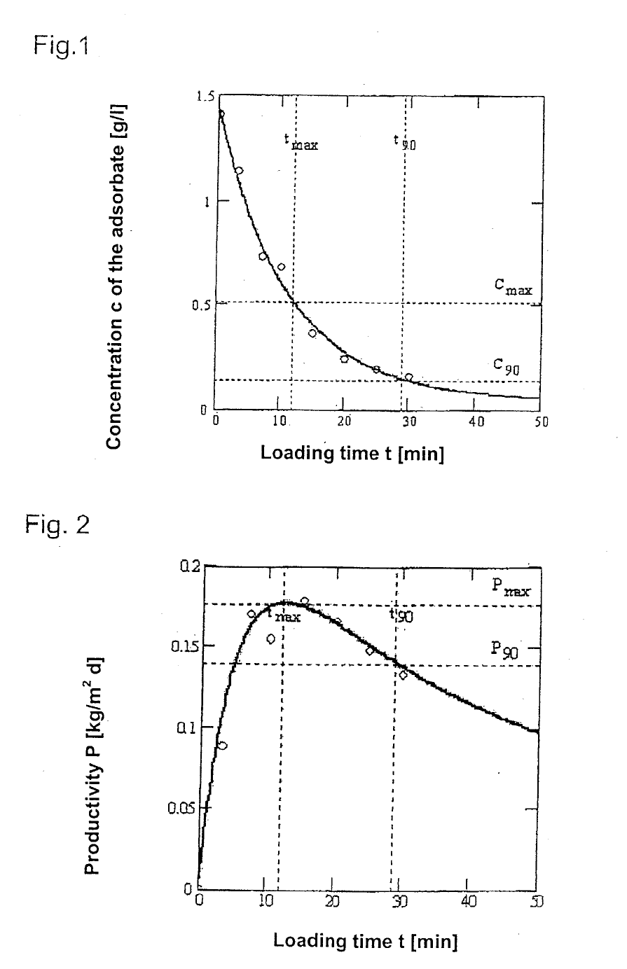

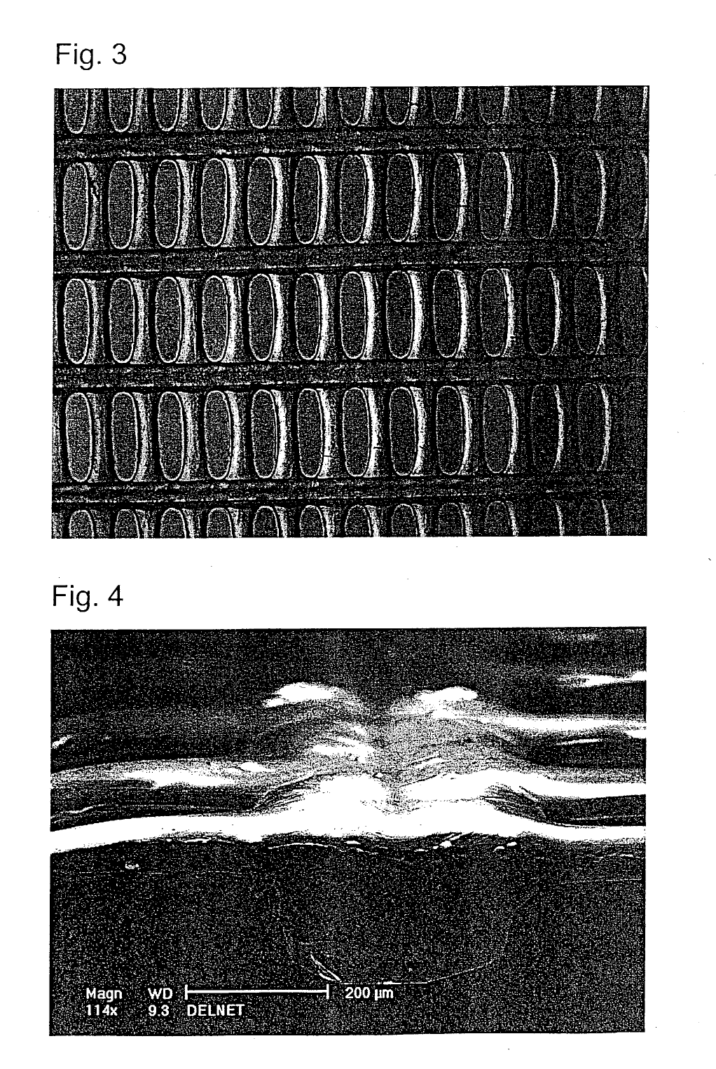

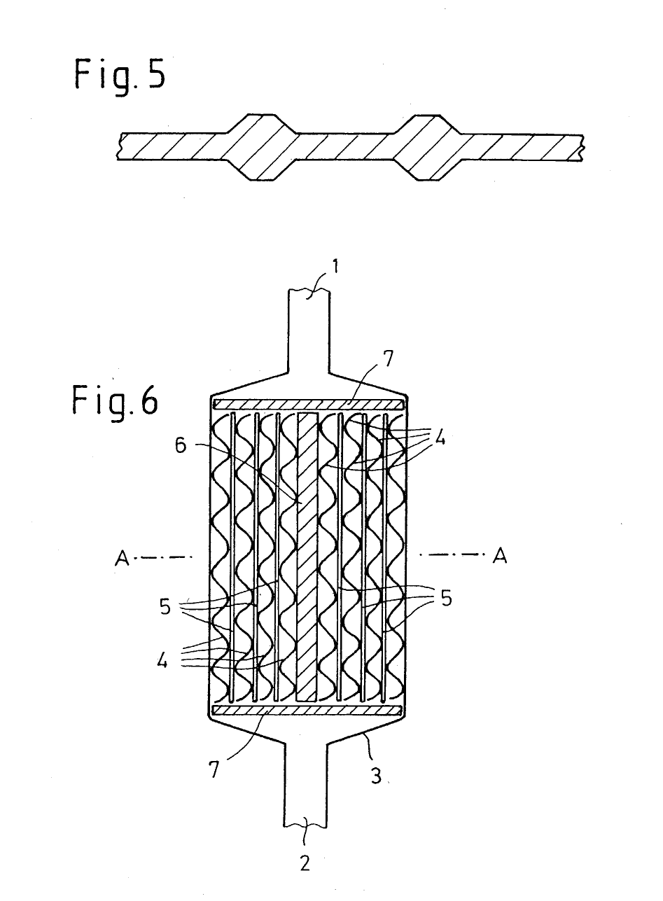

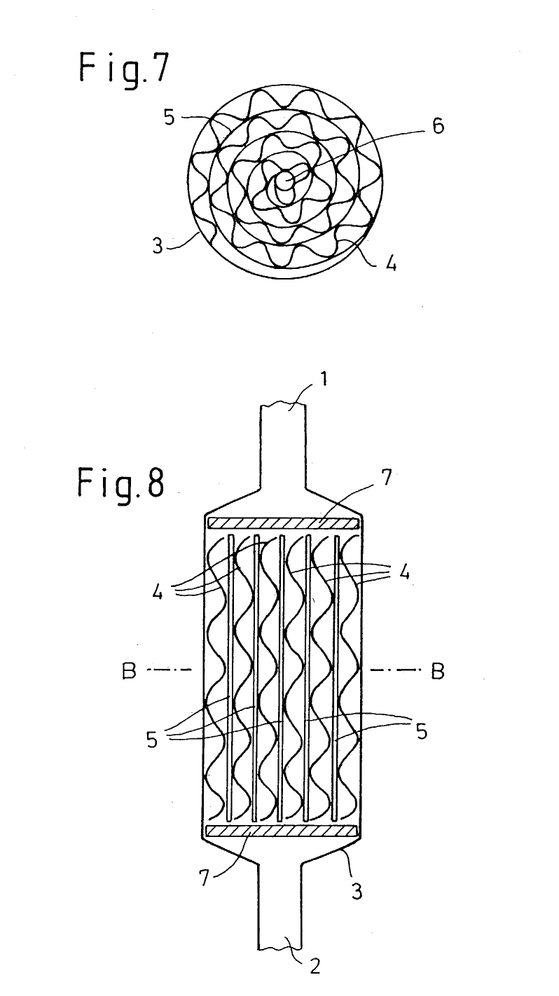

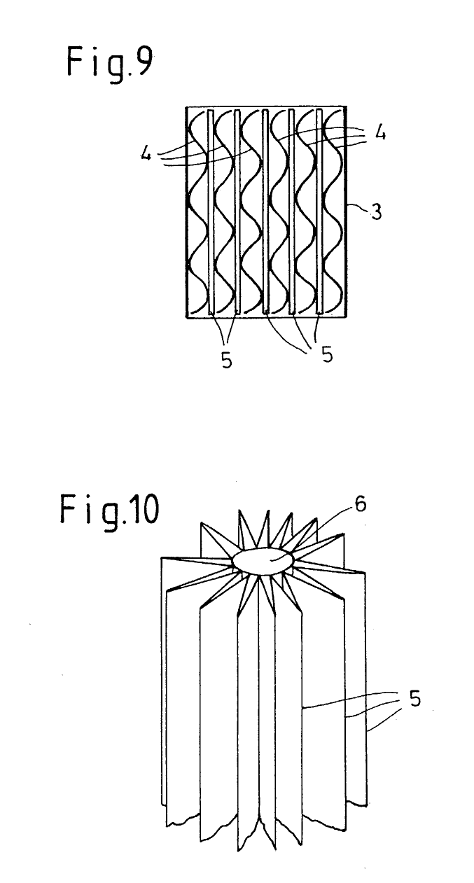

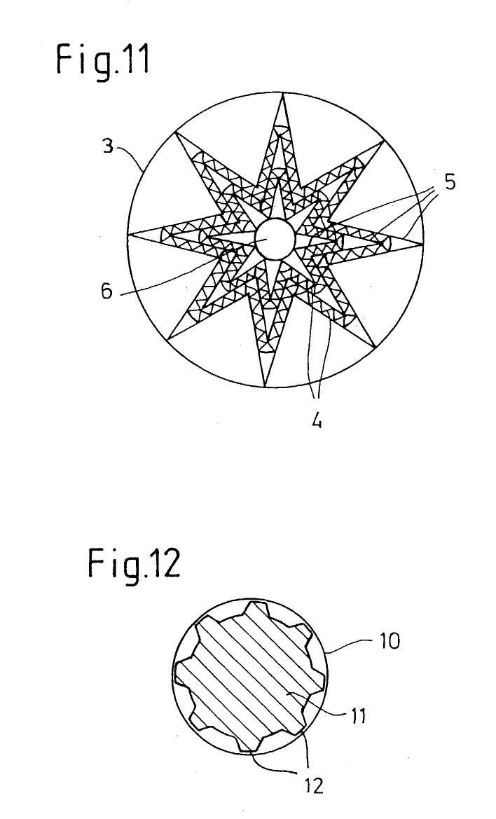

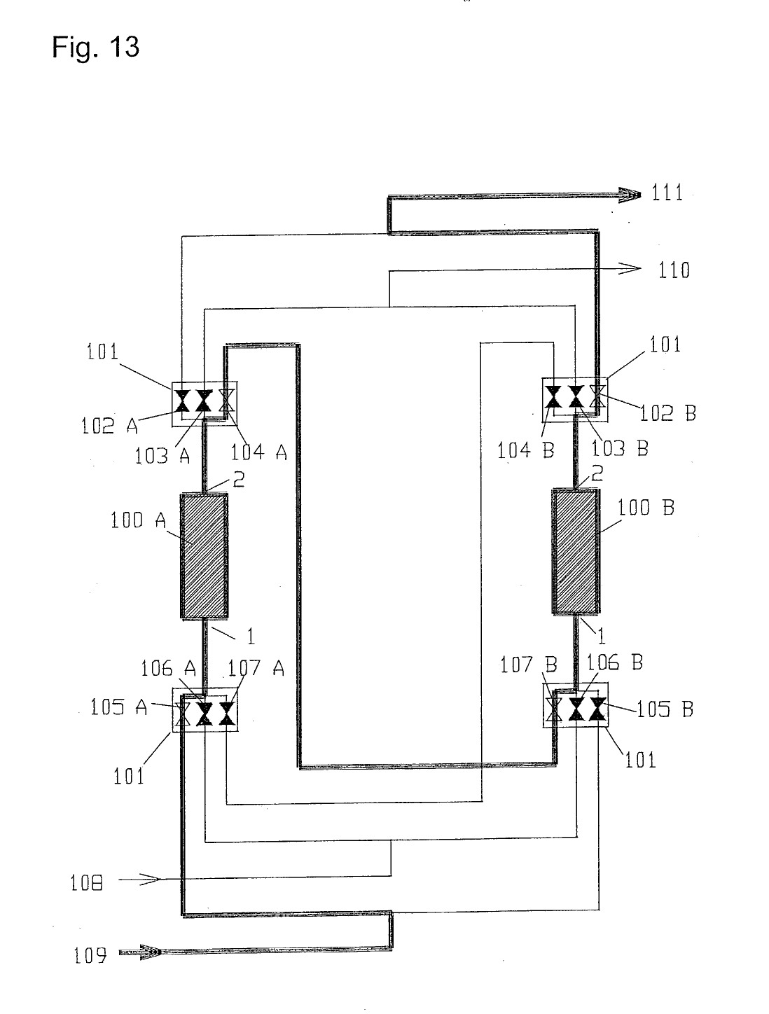

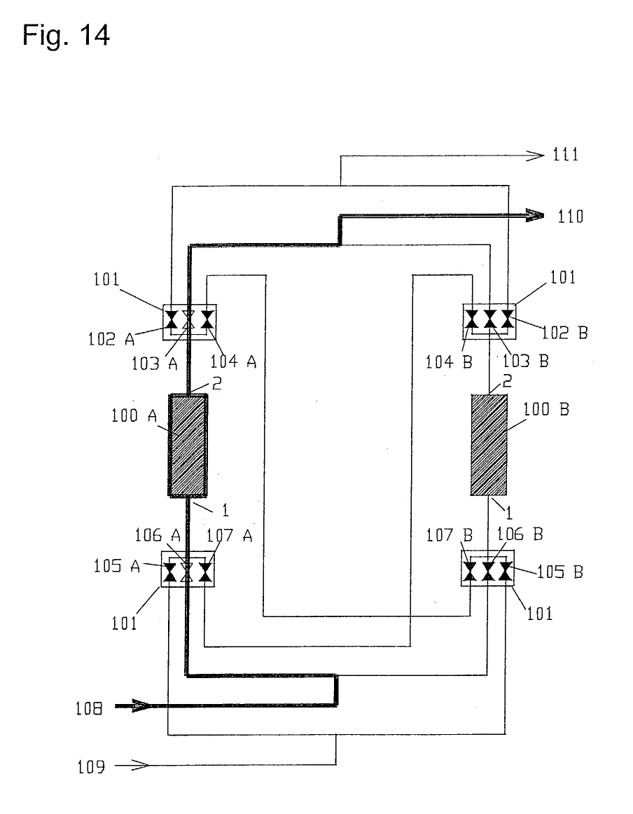

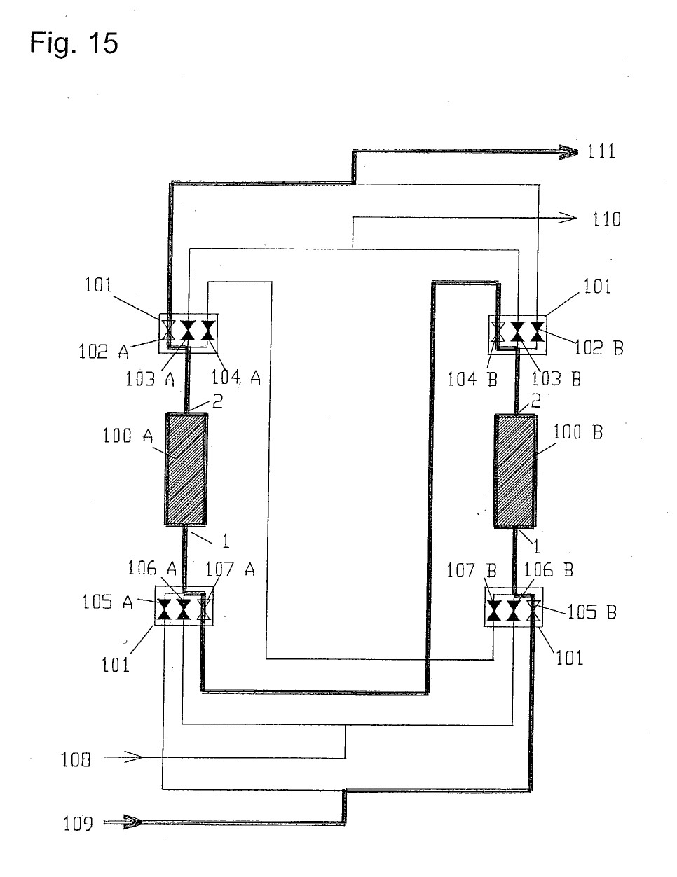

It describes first-order reaction kinetics with a residual content of the reactant, where a is the vector of the 3 parameters which are obtained by nonlinear regression calculation from experimental values of the concentration C and time t. In FIG. 1, the continuous curve shows a graph of this function and the individual points indicated are the experimental values of t and c from example 1, table 1.

In the case of example 3, the regression calculation for a₂, however, gave a slightly negative value (−1.8%, based on a₀). Reasons for this may be measurement inaccuracies, or the possibility mentioned above of a loss of activity of the enzyme during the experiment. In this case, before the curve fitting, the parameter a₂ was set to 0, which, for the example calculations, is without effect in principle.

The symbols, units and calculations used are summarized in table 6.

TABLE 6
Symbols and units used

| Symbol, designation and unit | Calculation |
|---|---|
| VF = volume/area ratio [l/m²] | — |
| t = loading time [min] | — |
| tₑ = elution time [min] | — |
| C = concentration at time point t [g/l] | $C = {a}_{0} exp ( - {a}_{1} t ) + {a}_{2}$ |
| K = capacity [g/m²] | $K {=}_{0} V$ |
| P = productivity [kg/m² d] | $P = \frac{V \cdot {a}_{0} \cdot ( 1 … exp ( - {a}_{1} \cdot t ) )}{( t + {t}_{e} )} \cdot 1.44$ |
| tₘₐₓ = t at maximum productivity [min] | Numerically |
| A = yield [%] | $A = \frac{{a}_{0} \cdot ( 1 - exp ( - {a}_{1} \cdot t ) )}{{a}_{0} + {a}_{2}} \cdot 100$ |
| A_{inf} = yield at t = ∞ [%] | ${A}_{ln1} = \frac{{a}_{0}}{{a}_{0} + {a}_{2}} \cdot 100$ |
| t_{A} = t at yield = A% [min] | ${t}_{A} = \frac{- ln [ 1 - \frac{A}{100} \cdot \frac{( {a}_{0} + {a}_{2} )}{{a}_{0}} ]}{{a}_{1}}$ |
| P_{A} = at yield = A% [kg/m² d] | ${P}_{A} = \frac{A \cdot V \cdot ( {a}_{0} + {a}_{2} ) \cdot {a}_{1} \cdot 0.0144}{- ln [ 1 - \frac{A}{100} \cdot \frac{( {a}_{0} + {a}_{2} )}{{a}_{0}} ] + {t}_{c} \cdot {a}_{1}}$ |

Capacity and kinetic data of a given system only apply to the volume/area ratio VF chosen for the measurement, because K depends on the adsorption isotherms of the adsorbent, and thus also physically on C_{inf}. Determination of the kinetic parameter a₁ can be used in the study of the suitability of various spacers and for determining the effect of recirculation rate on binding kinetics, by varying spacer or recirculation rate under otherwise identical conditions. Using the relationship for t_{A}, the loading time required to achieve a defined residual concentration can be calculated. The elution time which co-determines productivity depends on the requirements of the respective process (for example number and time of wash steps) and was assumed to be uniformly 10 min for the calculation examples.

FIG. 2 shows the values of P calculated from example 1 together with the assumed value of te=10 min, and also the graph of P calculated from the parameters a. It was found that P passes through a maximum. The position of this maximum, tmax, was obtained by a numerical solution of the expression obtained in the differentiation of P with respect to t. By means of the calculation program used (Mathcad 8 Professional, English version, from Mathsoft Inc., Cambridge, Mass.), the following relationship was found:

$${t}_{max} = {\vert}_{root [ {a}_{0} \cdot {a}_{1} \cdot exp ( - {a}_{1} \cdot t ) - \frac{( {a}_{0} - {a}_{0} \cdot exp ( - {a}_{1} \cdot t ) )}{( t + {t}_{c} )} , t ]}^{t - 1}$$

t₉₀ is the loading time for which the yield is 90%. For the values of P, A given at t=tₘₐₓ and t=t₉₀, the indices “max” and “90” are employed hereinafter. In FIGS. 1 and 2, tₘₐₓ and t₉₀ and the corresponding function values Cₘₐₓ and C₉₀, and Pₘₐₓ and P₉₀, are labeled.

Table 7: Overview of the characteristics of examples 1, 3 and 4. (The unit g or kg applies to examples 1 and 4, U, or kU, to example 3)

| Parameter | Example 1 | Example 3 | Example 4 |
|---|---|---|---|
| Adsorbate | BSA | LP | Mixture |
| Adsorbent | Sartobind ® D | Sartobind ® S | Sartobind ® D |
| VF [l/m²] | 2.96 | 7.14 | 2.96 |
| tₑ [min] | 10*⁾ | 10*⁾ | 10*⁾ |
| a₀ [g or U/l] | 1.39 | 7.490 | 2.97 |
| a₁ [min⁻¹] | 0.0899 | 0.0369 | 0.535 |
| a₂ [g or U/l] | 0.0406 | 0 | 0.787 |
| A_{inf} [%] | 97.2 | 100 | 79.1 |
| K [g or U/m²] | 4.11 | 53.500 | 8.79 |
| tₘₐₓ [min] | 12.0 | 20.4 | 3.99 |
| t₉₀ [min] | 29.0 | 62.4 | — |
| Cₘₐₓ [g or U/l] | 0.514 | 3.530 | 1.14 |
| C₉₀ [g or U/l] | 0.143 | 749 | — |
| Pₘₐₓ [kg or kU/m² d] | 0.140 | 1.340 | 0.798 |
| P₉₀ [kg or kU/m² d] | 0.150 | 957 | — |
| Aₘₐₓ [%] | 64.7 | 52.8 | 69.7 |

*⁾Assumed value

tₘₐₓ is not only the position of the productivity maximum, but also the minimum of an expedient loading time, because at shorter loading times not only does the productivity fall steeply, as can be seen from FIG. 2, but also the yield.

In example 3, no values for A=90% exist, because A_{inf} is only 79.1%. Higher yields are therefore only possible at smaller values of VF. If the yield Aₘₐₓ=69.7% achieved in this example is sufficient, that is 88.1% of the value A_{inf}=79.1% obtained at the volume/area ratio used, then in this example, without further loss of yield, a considerable increase in productivity is possible if technical measures succeed in shortening the required elution time: a halving of tₑ to 5 min corresponds in this case to an increase in productivity by 55.6% to 1.24 kg/m² d. For comparison: a similar procedure in example 3 only leads to an increase by 19.6%.

In example 3, there is complete binding (A_{inf}=100%). Whether this also occurs at a larger value of VF can only be determined by experiment. Considering the fact that, in the underlying technical process, the production of LP from whey, and lactoperoxidase production from whole milk, the height of the yield is not critical, it appears useful to incorporate the volume/area ratio into process optimization. In any case, the process optimum should be close to tₘₐₓ.

1. A process for the adsorption separation of substances in liquid media, comprising the steps:
(a) providing an adsorber having a flat absorbent (5) which is disposed fixed in position in a housing (3) and has at least one adsorbing surface which is designed for binding an adsorbate, the housing (3) having at least one intake (1) and at least one outlet (2) for liquid medium,
(b) optionally equilibrating the adsorbent (5) with a liquid medium and
(c) contacting the flat adsorbent (5) in the housing (3) with the liquid medium which comprises at least one adsorbate by applying a pressure difference between intake (1) and outlet (2), the at least one adsorbate-containing medium flowing tangentially over the entire outer adsorbing surface of the adsorbent (5).

2. The process as claimed in claim 1 which further comprises the step
(d) contacting with an eluent the adsorbent (5) which has at least one adsorbate adsorbed thereto in step (c).

3. The process as claimed in claim 1, wherein the liquid medium comprising at least one adsorbate additionally contains particles.

4. The process as claimed in claim 1, wherein the liquid medium which leaves the outlet (2) in step (c) is recirculated to the intake (1).

5. The process as claimed in claims 1, wherein the liquid medium, after being contacted with the adsorbent (5) in step (c), is filtered through a final adsorption membrane.

6. The process as claimed in claim 5, wherein the final adsorption membrane is also disposed in the housing (3) in the direction of flow upstream of the outlet (2).

7. The process as claimed in claim 5, wherein the final adsorption membrane is disposed downstream of the outlet (2).

8. The process as claimed in claim 1, wherein the adsorbent (5) is disposed in multiple layers in the housing (3).

9. The process as claimed in claim 8, wherein the adsorbent (5) is disposed in the housing (3) wound in a spiral shape around a fluid-tight core (6).

10. The process as claimed in claim 8, wherein devices (4) which produce a spacing between the adsorbent layers and through which flow can pass tangentially are disposed between the adsorbent layers.

11. The process as claimed in claim 1, wherein the adsorbent (5) is constructed in capillary form.

12. The process as claimed in claim 1, comprising the steps:
(a′) providing two adsorbers each having a flat adsorbent (5) disposed fixed at a point in a housing (3), which adsorbers are connected by lines (108, 109, 110, 111) having valves (102A-107A, 102B-107B) in series in such a manner that each adsorber can as desired be triggered first and independently from the other,
(b′) optionally equilibrating the adsorbents (5) with a liquid medium,
(c′) sequentially and continuously contacting the two adsorbents (5) disposed in the adsorbers with a liquid medium,
(d′) eluting the adsorbent (5) of the adsorber which is connected in the first position,
(e′) sequentially and continuously, but in reverse sequence, contacting the two adsorbents (5) disposed in the adsorbers,
(f′) eluting the adsorbent (5) of the adsorber connected in the second position, and
(g′) repeating the steps (c′)-(f′).

13. The process as claimed in claim 12, wherein at least one further adsorber is disposed between the two adsorbers, and in the step (d′) or (f′) in each case only the adsorbent (5) is eluted which is connected at the first position or the last position of the series-connected adsorbers, and the adsorbents (5) of the other adsorber in the respective following step (e′) or (c′) is successively and continuously brought into contact with the liquid medium.

14. An apparatus for the adsorption separation of substances in liquid media comprising:
an adsorber comprising
a housing (3) having at least one intake (1) and at least one outlet (2) for liquid medium and
a flat adsorbent (5) having at least one adsorbing surface side which is designed for binding at least one adsorbate and is disposed fixed in position in the housing (3),
the medium flowing tangentially over the entire adsorbing outer surface of the adsorbent (5).

15. The apparatus for the adsorption separation of substances in liquid media comprising:
an adsorber comprising
a housing (3) having at least one intake (1) and at least one outlet (2) for liquid medium and
a flat adsorbent (5) which has two adsorbing surface sides, is designed for binding
at least one adsorbate, and is disposed in a fixed position in the housing (3), the medium flowing over the entire adsorbing outer surface of the adsorbent (5) in such a manner that the velocity of the medium at points of the surface sides which are opposite in each case is the same averaged over time.

16. The apparatus as claimed in claim 14 wherein the adsorbent (5) is disposed in multiple layers in the housing (3).

17. The apparatus as claimed in claim 15 wherein the adsorbent (5) is disposed in multiple layers in the housing (3).

18. The apparatus as claimed in claim 16, the adsorbent (5) being disposed in the housing (3) coiled in a spiral form around a fluid-tight core (6).

19. The apparatus as claimed in claim 14, wherein devices (4) which produce a spacing between the adsorbent layers and through which flow can pass tangentially are disposed between the adsorbent layers.

20. The apparatus as claimed in claim 14, wherein the adsorbent (5) is constructed in capillary form.

21. The apparatus as claimed in claim 14 which further comprises a final adsorption membrane which is dispersed in such a manner that the medium, after being contacted with the adsorbent (5) is filtered through the final adsorption membrane.

22. The apparatus as claimed in claim 20, wherein the final adsorption membrane is disposed in the housing (3).

23. The apparatus as claimed in claim 20, wherein the final adsorption membrane is disposed downstream of the outlet (2).

24. The apparatus as claimed in claim 14, wherein two adsorbers in each case comprising a housing (3) having a flat adsorbent (5) disposed therein are connected in series and are connected via lines (108, 109, 110, 111) to valves (102A-107A, 102B-107B) in such a manner that each adsorber can as desired be triggered first and each adsorbent (5) which is disposed in a housing (3) can be loaded and eluted independently of the other.

25. The apparatus as claimed in claim 23, wherein at least one further adsorber is disposed between the two adsorbers.
